(19) United States
(12) Patent Application Publication
(10) Pub. No.: US 2021/0279372 A1
(43) Pub. Date: Sep. 9, 2021

(54) FABRIC DETECTING AND RECORDING METHOD AND APPARATUS

(71) Applicant: SHENZHEN LINTSENSE TECHNOLOGY COMPANY LIMITED, SHENZHEN (CN)

(72) Inventors: LINGLING JIN, SHENZHEN (CN); TENGFA LUO, SHAOXING (CN)

(21) Appl. No.: 17/330,433

(22) Filed: May 26, 2021

Related U.S. Application Data
(63) Continuation of application No. PCT/CN2019/077615, filed on Mar. 11, 2019.

(30) Foreign Application Priority Data
Nov. 30, 2018 (CN) 201811452522.X

(51) Int. Cl. G06F 21/64; G06T 7/00; H04L 9/32

(52) U.S. Cl. CPC G06F 21/64; G06T 7/0002; H04L 2209/38; G06T 2207/30124; H04L 9/3239

(57) ABSTRACT

The present disclosure discloses a fabric detecting and recording method and apparatus. The method includes: acquiring a fabric identification of a fabric to be detected; acquiring an image data of a current detecting part of the fabric to be detected; detecting defects on the image data, if there is a defect on the detecting part included in the image data, a detection data corresponding to the detecting part will be generated; packaging the fabric identification and the detection data into a detection data packet, and sending the packet into the blockchain network for broadcasting. The blockchain technology is used in the solution of the embodiments of the present disclosure to broadcast the fabric detection data in real time through the blockchain network, without any manual uploading operation, thus to reduce the risk of data being tampered with during the uploading stage.

### TECHNICAL FIELD

The present disclosure relates to detecting and recording technology fields, and more particularly to a fabric detecting and recording method and apparatus.

### RELATED ART

Textiles are performed a series of detection before they can enter the market. After detecting, the detection data of the existing textile detection are entered by manual operation and the textile detection results are generated at local. The detection results are stored in a database or file system, users can print the detection results as paper files or send electronic files of the detection results through emails and the like; however, the textile detection results are easily lost or tampered with, which has great risk of storage.

### SUMMARY

In view of the shortcomings of the related art, embodiments of the present disclosure provide a fabric detecting and recording method and apparatus, which can solve the above-mentioned technical problems.

In a first aspect, a fabric detecting and recording method according to an embodiment of the present disclosure includes: acquiring an image data of a current detecting part of a fabric to be detected; detecting the image data to generate a detection data corresponding to the detecting part; packaging the fabric identification and the detecting data into a detection data packet and sending the packet to a blockchain network for broadcasting.

In a second aspect, the fabric detecting and recording method according to an embodiment of the present disclosure includes: receiving a detection data packet of a fabric to be detected, wherein the detection data packet includes a fabric identification of the fabric to be detected and a detecting data corresponding to a current detecting part of the fabric to be detected; storing the detection data packet in a memory pool; when satisfying a preset condition, collecting the detection data packet that meets a preset rule in the memory pool; generating a block according to the collected detection data packet and writing the block into a blockchain.

In a third aspect, the fabric detecting and recording method according to an embodiment of the present disclosure includes: a first acquiring module for acquiring a fabric identification of a fabric to be detected; a second acquiring module for acquiring an image data of a current detection part of the fabric to be detected; a detection generating module for detecting the image data to generate a detection data corresponding to the detecting part; and a package sending module for packaging the fabric identification and the detection data into a detection data packet and sending the packet to a blockchain network for broadcasting.

In a fourth aspect, the fabric detecting and recording method according to an embodiment of the present disclosure includes: a receiving module for receiving a detection data packet of a fabric to be detected, wherein the detection data packet includes a fabric identification of the fabric to be detected, and a detection data corresponding to a current detection part of the fabric to be detected; a storage module for storing the detection data packet into a memory pool; a collecting; module for collecting the detection data packet in the memory pool that meets a preset rule when a preset condition is satisfied; and a writing module for generating and writing a block into a blockchain according to the collected detection data packet.

In a fifth aspect, a terminal device according to an embodiment of the present disclosure includes a processor, and a memory having executable instructions stored therein, when the executable instructions are executed, the processor performs the fabric detecting and recording method in the aforementioned first aspect.

In a sixth aspect, a computing device according to an embodiment of the present disclosure includes a processor, and a memory having executable instructions stored therein, when the executable instructions are executed, the processor performs the fabric detecting and recording method in the aforementioned second aspect.

In a seventh aspect, a computer storage medium according to an embodiment of the present disclosure is used for storing program codes, and the storing program codes are used for performing the fabric detecting and recording method of the present disclosure.

In an eighth aspect, when an instruction in the computer program product is performed by a processor, a computer program product according to an embodiment of the present disclosure performs the fabric detecting and recording method.

From the above description, the blockchain technology is used in the solution of the embodiments of the present disclosure to broadcast the fabric detection data in real time through the blockchain network, without any manual uploading operation, thus to reduce the risk of data being tampered with during the uploading stage. Furthermore, the detection data for broadcasting is recorded in the blockchain, which can effectively reduce the risk of fabric detection data loss and being tampered with during the storage stage.

### BRIEF DESCRIPTION OF THE DRAWINGS

FIG. 1 is a scene architecture view of a fabric detecting and recording method according to an embodiment of the present disclosure.

FIG. 2 is an interactive flowchart of the fabric detecting and recording method according to an embodiment of the present disclosure.

FIG. 3 is an interactive flowchart of the fabric detecting and recording method according to another embodiment of the present disclosure.

FIG. 4 is a schematic view of the fabric detecting and recording method according to an embodiment of the present disclosure.

FIG. 5 is a schematic view of the fabric detecting and recording method according to another embodiment of the present disclosure.

FIG. 6 is a schematic view of a fabric detecting apparatus according to an embodiment of the present disclosure.

FIG. 7 is a schematic view of the fabric detecting apparatus according to another embodiment of the present disclosure.

FIG. 8 is a schematic structural view of a terminal device according to an embodiment of the present disclosure.

FIG. 9 is a schematic structural view of a computing device according to an embodiment of the present disclosure.

### DETAILED DESCRIPTION

The subject matter described herein will now be discussed with reference to example embodiments. It should be understood that discussions of these embodiments are merely to enable those skilled in the art to better understand and realize the subject matter described herein, and are not to limit the scope of protection, applicability, or examples set forth in the claims. The functions and arrangements of the discussed elements can be changed without departing from the scope of protection of the present disclosure. Various examples may be omitted, substituted, or added various procedures or components as needed. For example, the described method may be performed in a different order from the described order, and various steps may be added, omitted, or combined. In addition, features described with respect to some examples can also be combined in other examples.

As used herein, a term “include” and its variations refer to open terms, meaning “including but not limited to”. A term “based on” means “based at least in part on”, and terms “one embodiment” and “an embodiment” mean “at least one embodiment”. A term “another embodiment” means “at least one other embodiment”; terms “first”, “second”, etc. may refer to different or the same objects, and “below” may include other definitions, whether explicit or implicit.

To make the technical solution of the present disclosure clearer, the fabric detecting and recording method provided by the embodiments of the present disclosure will be described in conjunction with particular scenes.

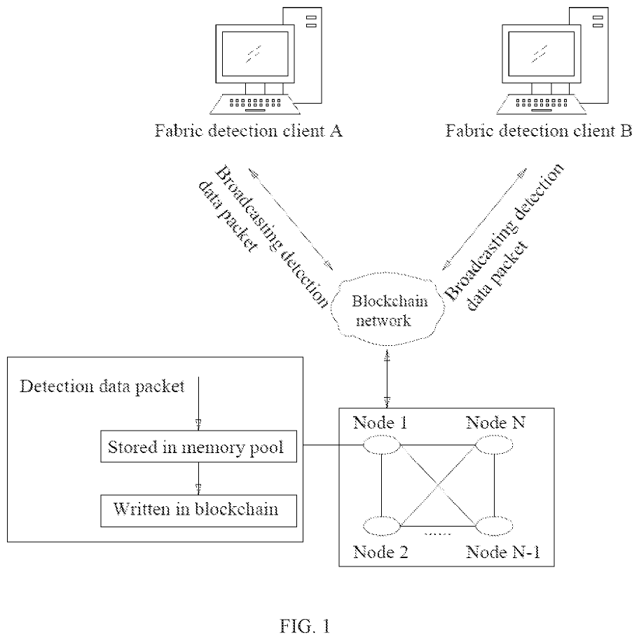

FIG. 1 is a scene architecture view of a fabric detecting and recording method according to an embodiment of the present disclosure. As shown in FIG. 1, FIG. 1 includes a fabric detection client A, a fabric detection client B and nodes 1 to N, wherein N is a positive integer. The fabric detection client A, the fabric detection client B and the nodes 1 to N are all located in a blockchain network, wherein the fabric detection client A runs on one terminal device, the fabric detection client B runs on another terminal device, and the nodes 1 to node N are all computing devices. The fabric detection client A and the fabric detection client B are used to detect images of a fabric to be detected, and the nodes 1 to N are used to verify the detection data uploaded by the fabric detection client A and the fabric detection client B, and to store the detection data passed the verification in the memory pool and further write into a blockchain for recording.

Specifically, the fabric detection client A and the fabric detection client B perform fabric detection respectively, package detection data generated each time during the detecting process with a fabric identification of the fabric to be detected into a detection data packet, and send the detection data packet to the blockchain network for broadcasting in real time. The nodes 1 to N verify the detection data packets sent by the fabric detection client A and the fabric detection client B, and the detection data packets passed the verification are stored in the memory pools of the nodes 1 to N. When a node device receives a preset instruction and obtains an accounting right, it collects the detection data packets with the same fabric identification to generate a block, and write the generated block into the blockchain to complete the recording of all detection data of the fabric with the fabric identification. It should be noted that the node 1 is used as an example for illustration in FIG. 1, and other nodes also need to conduct verification and write the detection data to the blockchain according to the consensus between the nodes.

Specifically, since the fabric to be detected is usually a roll fabric and has a certain length, when the fabric to be detected is detected, it is spread on a fabric detecting machine and is continuously transported to a detecting area. A camera above the detecting area collects fabric images currently in the detecting area, and sends the collected images to the fabric detection client A or the fabric detection client B for detecting. Therefore, a roll fabric to be detected needs to be collected multiple times, and the fabric detection client A or the fabric detection client B needs to detect multiple images of a whole fabric to be detected in turn.

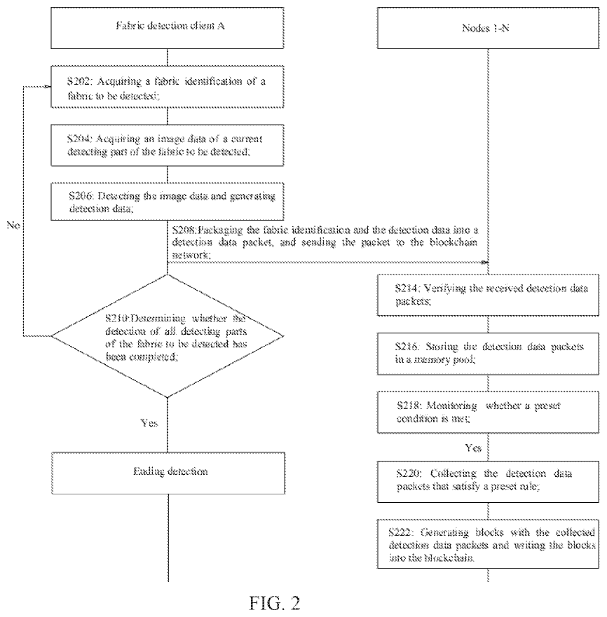

In order to facilitate understandings, the fabric detecting and recording method according to an embodiment of the present disclosure will be described below in conjunction with the scene architecture of FIG. 1. Please refer to FIG. 2, which is a schematic view of an interactive embodiment of the fabric detecting and recording method according to an embodiment of the disclosure. In this embodiment, the fabric detection client A is taken as an example, and the fabric client A runs on a terminal device. As shown in FIG. 2, the method specifically comprises:

S202: A fabric detection client A acquires a fabric identification of a fabric to be detected.

S204: The fabric detection client A acquires an image data of a current detecting part of the fabric to be detected.

S206: The fabric detection client A detects the image data to generate a detection data corresponding to the detecting part.

S208: Packaging the fabric identification and the detection data into a detection data packet, and sending the packet to a blockchain network for broadcasting.

S210: The fabric detection client A determines whether the detection of all detecting parts of the fabric to be detected has been completed, if not, it returns to step S202 and repeats the operation of steps S202-S208; if yes, the fabric detection client A ends the detection.

S212: The nodes in the blockchain network verify the received detection data packets.

S214: If the verification is passed, the nodes in the blockchain network store the detection data packets in a memory pool, and if the verification is failed, discard the detection data packets.

S216: The nodes in the blockchain network monitor whether a preset condition is met, and if yes, perform the operation of step S218.

S218: The nodes in the blockchain network collect the detection data packets in the memory pool that satisfy a preset rule.

S220: The nodes in the blockchain network generate blocks with the collected detection data packets and write the blocks into the blockchain.

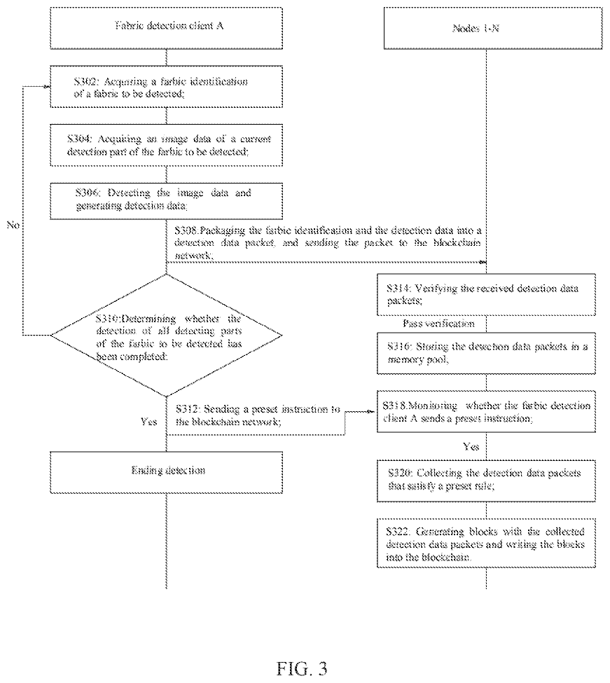

In other implementations, as shown in FIG. 3, the method specifically comprises:

S302: A fabric detection client A acquires a fabric identification of a fabric to be detected.

S304: The fabric detection client A acquires an image data of a current detecting part of the fabric to be detected.

S306: The fabric detection client A detects the image data to generate a detection data corresponding to the detecting part.

S308: Packaging the fabric identification and the detection data into a detection data packet, and sending the packet to a blockchain network for broadcasting.

S310: The fabric detection client A determines whether the detection of all detecting parts of the fabric to be detected has been completed, if not, it returns to step S302 and repeats the operations of steps S302-S308; if yes, it performs the operation of step S312 and ends the detection.

S312: The fabric detection client A sends a preset instruction to the nodes in the blockchain network.

S314: The nodes in the blockchain network verify the received detection data packets.

S316: If the verification is passed, the nodes in the blockchain network store the detection data packets in a memory pool, and if the verification is failed, discard the detection data packets.

S318: The nodes in the blockchain network monitor whether the fabric detection client A sends a preset instruction, and if yes, it performs the operation of step S320.

S320: The nodes in the blockchain network collect the detection data packets in the memory pool that satisfy a preset rule.

S322: The nodes in the blockchain network generate blocks with the collected detection data packet and write the blocks into the blockchain.

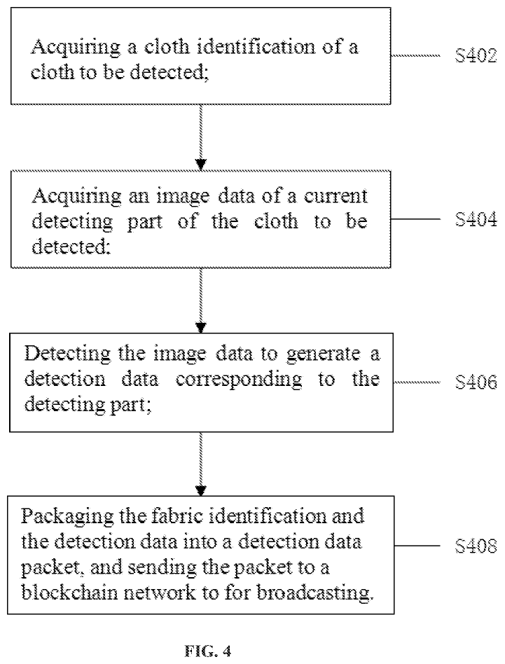

The fabric detecting and recording method in an embodiment of the present disclosure will be described below from a view of the fabric detection client. Referring to FIG. 4, an embodiment of the fabric detecting and recording method of the present disclosure includes:

S402: Acquiring a fabric identification of a fabric to be detected.

The fabric identification of the fabric to be detected is unique identification information of the fabric to be detected, for example, an RFID tag can be set on the fabric to be detected, and then the identification information is written in the RFID tag. The identification information of the fabric to be detected may be manually entered into the fabric detection clients before detecting, or an RFID reader can be set o read the fabric identification in the RFID tag and then send to the fabric detecting clients.

S404: Acquiring an image data of a current detecting part of the fabric to be detected.

The image data of the fabric to be detected may be collected by an image acquiring module which can be a CMOS (Complementary Metal Oxide Semiconductor) camera, a CCD (Charge Coupled Device) camera or a CIS (Contact Image Sensor) camera. The image acquiring module is arranged above the detecting area for collecting the image data of the fabric in the detecting area, and a fabric currently located in the detecting area is a current detecting part of the fabric to be detected. The fabric to be detected is continuously transmitted through the detecting area by a fabric transmission device, so that each detection part of the fabric to be detected can be continuously collected by the image acquiring module. When the fabric has been transmitted fully, the collection of all detection parts of the fabric to be detected is completed.

S406: Detecting the image data to generate a detection data corresponding too the detecting part.

The detecting contents may include a defect detection or an attribute detection. The detecting .methods may include but not limited to, for example, Neural Network Model, Normalized Gray-Scale Correlation Matching, Least Square Image Matching, Geometric Primitive Method, Fourier Shape Description Method, etc. The defect detection can include detecting defect types, defect sizes or defect location information, etc., wherein the defect types include such as but not limited to spots, yarn defects, weaving defects, printing and dyeing defects, edge defects, wrinkles, weft skews, and holes. The fabric detection client generates the detection data corresponding to the detecting part according to different detecting contents. For example, the detection result of the detecting part contains 2 holes and 1 broken yarn, so the corresponding detection data is 2 holes and 1 broken yarn. Furthermore, on this basis, points of the detected defects can be deducted according to the four-point system or the ten-point system, and the deducted points are also included in the detection data.

S408: Packaging the fabric identification and the detection data into a detection data packet, and sending the packet to a blockchain network for broadcasting.

In specific application, after the detection data is generated, the fabric detection clients combine the detection data of the current detecting part and the fabric identification of the fabric to be detected to generate a detection data packet of the detecting part, and then send the detection data packet to a blockchain network for broadcasting. In this way, the nodes the blockchain network can verify the detection data packet after receiving the detection data packet, and store the detection data packet passed the verification in the memory pool as a detection data to be written, in order to write into the blockchain later and record the detection data included in the detection data packet.

In one implementation, when the detection of all detecting parts of the fabric to be detected has been completed, the above method further includes the following content: sending a preset instruction to the blockchain network so that the nodes in the blockchain network collect the detection data packets that meet the preset rule and generate a block for writing into the blockchain according to the collected detection data packets. In this embodiment, meeting the preset rule includes having the same fabric identification or sending to the blockchain network for broadcasting at the same time period.

In specific application, since the fabric to be detected can be a roll fabric with a long length, the image acquiring module can only collect a limited detecting part each time, thus the same fabric to be detected is composed of multiple detecting parts, and there are multiple detection data packets transmitted to the blockchain network successively. Since multiple fabric detection clients can detect the fabrics with different identifications at the same time and send detection data packets to the blockchain network, thus multiple detection data packets with different fabric identifications are stored in the memory pool of the nodes in the blockchain network. When a fabric detection client completes the detection of a fabric to be detected, that is, after all the detection parts of the fabric to be detected have been collected and detected by the fabric detection client, a preset instruction can be sent to the blockchain network so that the node in the blockchain network starts to collect the detection data packet corresponding to a certain fabric identification and to generate a block. The preset instruction may include a fabric identification and information indicating that the detection of the fabric to be detected has been completed.

It can be seen from the above that the embodiment of the present disclosure provides a fabric detecting and recording method. When performing fabric detection, the fabric detection clients upload the detection data of each detecting part of the fabric to be detected to the blockchain network for broadcasting in real time, without any manual uploading operation, which can reduce the risk of data being tampered with during the uploading stage. Furthermore, after the fabric to be detected has been finished detecting, the detection data for broadcasting is recorded in the blockchain, which can effectively reduce the risk of fabric detection data loss and being tampered with in the storage stage.

The fabric detecting and recording method provided by the above embodiment of the disclosure is described from the view of the fabric detection client, it will be described below from a view of the node, and the node may be a computing device.

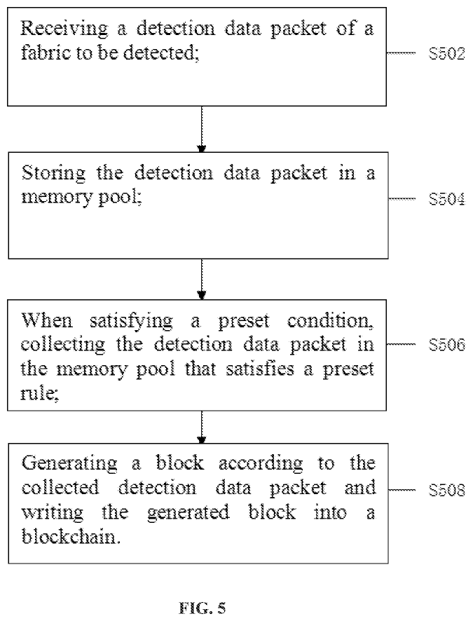

Referring to FIG. 5, an implementation of the fabric detecting and recording method in the embodiment of the present disclosure includes:

S502: Receiving a detection data packet of a fabric to be detected, wherein the detection data packet includes a fabric identification of a fabric to be detected and a detection data corresponding to a current detecting part of the fabric to be detected.

In this embodiment, the detection data packet is sent to the blockchain network by a fabric detection client in the form of broadcasting, and each node in the blockchain network can receive the detection data packet with detection data. The nodes can receive the detection data packet in many ways. In some possible implementations, since each node has a routing function, the node can receive the detection data packet through a routing of neighboring nodes. In other possible implementations, when the node is adjacent to the fabric detection client that broadcasts the detection data packet, it can receive the detection data packet sent by the fabric detection client.

S504: Storing the detection data packet in a memory pool.

In this embodiment, after receiving a new detection data packet, the node can perform a simple verification on the detection data packet to verify the validity of the detection data packet. For example, the detection data packet may further include a client identification of a fabric detection client, so the node can verify whether it is a fabric detection client with detecting qualifications according to the client identification. The node stores the detection data packet that has passed the verification into a memory pool as the detection data packet to be written.

The detection data packet stored in the memory pool will increase with the increasing detection data packets received by the nodes. The detection data packets can include multiple detection data packets of the same fabric to be detected sent by one fabric detection client, or multiple detection data packets of different fabrics to be detected sent by multiple fabric detection clients. The way used in the present disclosure by broadcasting the detection data packet corresponding to the current detecting part to the blockchain network in real time can avoid the risk of the detection data being tampered at local by humans.

In an embodiment, the above method further includes the following steps.

S506: When satisfying a preset condition, collecting the detection data packet in the memory pool that satisfies a preset rule.

In this embodiment, meeting a preset condition includes receiving a preset instruction, reaching a preset time, or the number of detected data packets stored in the memory pool reaching a preset threshold.

In this embodiment, satisfying a preset rule includes having the same fabric identification or being stored in the memory pool at the same time period.

In practice, in some possible implementations, meeting a preset condition may refer to having received a preset instruction sent by the fabric detection client, wherein the preset instruction may include a fabric identification of a fabric to be detected and completed detection information of the fabric to be detected. When receiving the preset instruction, the node searches for and collects the detection data packet corresponding to the fabric identification in the memory pool according to the fabric identification of the fabric to be detected. In another possible implementation, meeting a preset condition can also be that after a preset time of receiving a certain detection data packet, the node starts to search for and collect the detection data packets received in the time period in the memory pool, and the preset time can be set to be greater than or equal to a time for completing fabric detection. In another possible implementation, meeting a preset condition can also be that when the number of detection data packets stored in a memory pool reaches a preset threshold, the node starts to collect the corresponding data packets according to the cloth identifications of the detection data packets stored in the memory pool. If the number of detection data packets corresponding to the cloth identification is the largest, an operation of step S408 is preferentially performed on the detection data packet corresponding to the cloth identification, or, the detection data packet received within an initial time period is preferentially collected.

S508: Generating a block according to the collected detection data packet and writing a generated block into a blockchain.

In this embodiment, generating a block according to the collected detection data packet may specifically include: generating hash values of the fabric identification and the detection data according to the fabric identification and detection data in the collected detection data packet; calculating a root hash of the Merkel tree according the hash values of the fabric identification and the detection data; acquiring a timestamp of a current block; acquiring a hash value corresponding to a previous block; setting the hash value corresponding to a previous block, the root hash value of the Merkel tree, and the timestamp of the current block into a block header of the current block; setting a fabric identification and a detection data into a block body of the current block.

In practice, the hash value corresponding to the previous block is acquired by performing hash calculation on the data stored in the previous block. Specifically, the previous block includes a block header and a block body. The block header includes a hash value of the previous block and a root hash value of the Merkel tree of the previous block, and the two hash values are then performed hash calculation to acquire a hash value corresponding to the previous block.

The current block includes a block body having a fabric identification and a detection data stored therein, and a block header having a hash value corresponding to a previous block stored therein. Besides, the time stamp for generating the current block, the root hash value of the Merkel tree, the hash value stored in each leaf node of the Merkel acquired after performing hash calculation on the fabric identification and the detection data in the collected detection data packet, and the total hash value stored in the root node of the Merkel tree acquired by accumulating the hash values corresponding to the fabric identification and the detection data are stored in the block header.

In this embodiment, writing a generated block into a blockchain may specifically include: broadcasting a generated block; verifying the generated block according to a preset consensus mechanism; adding a verified block to an end of the blockchain, and broadcasting the blockchain.

In this embodiment, a plurality of blocks are stored in the blockchain, and two adjacent blocks are associated through the hash value corresponding to the previous block.

In this embodiment, the blockchain can include a public blockchain, an alliance blockchain, or a private blockchain.

It should be noted that the fabric detecting and recording method of this embodiment can be performed by one node or by a plurality of nodes. In some possible implementations, the step S502 and step S504 can be performed by one node called a verification node, while the step S506 and step S508 can be performed by another node called a packaging node.

It can be seen from the above that this embodiment provides a fabric detecting and recording method. When performing the fabric detection, the node stores a plurality of detection data packets of the fabric to be detected that are received successively into the memory pool. When the preset condition is met, a plurality of detection data packets that satisfy the rule are packaged to generate blocks, thus a calculations cost can be saved, and it is convenient to manage and search the detection data by recording the detection data of the same fabric identification via a block.

The above are specific implementation manners of the fabric detecting and recording method according to the embodiment of the present disclosure. Based on this, the embodiment of the present disclosure further provides a fabric detecting and recording apparatus, which will be described below from a view of functional modularity.

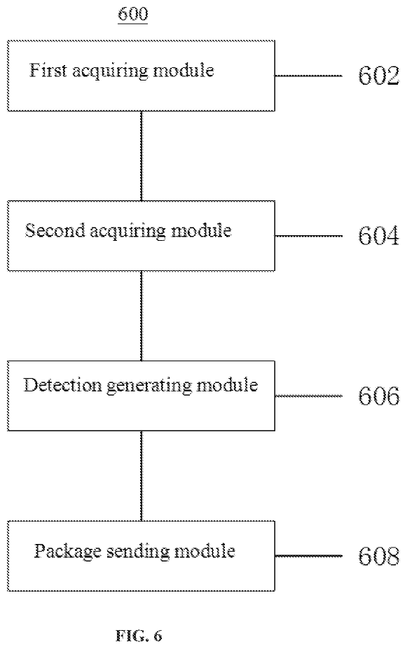

FIG. 6 is a schematic view of a fabric detecting and recording apparatus according to an embodiment of the present disclosure. The apparatus 600 may be implemented by using software, hardware or a combination of software and hardware. Since the embodiment of the apparatus 600 is basically similar to the embodiment of the method, the description is given briefly, and references may be made to the description of the method embodiment for relevant parts. Referring to FIG. 6, the apparatus 600 includes a first acquiring module 602 for acquiring a fabric identification of a fabric to be detected, a second acquiring module 604 for acquiring an image data of a current detection part of the fabric to be detected, a detection generating module 606 for detecting the image data to generate a detection data corresponding to the detecting part, and a package sending module 608 for packaging the fabric identification and the detection data into a detection data packet and sending the packet to a blockchain network for broadcasting.

In one aspect, the apparatus 600 further includes an instruction sending module 610 used for sending a preset instruction to a blockchain network when detection of all detecting parts of the fabric to be detected has been completed, so that nodes in the blockchain network collect detection data packet that meets a preset rule, and generate a block for writing into the blockchain according to the collected detection data packet.

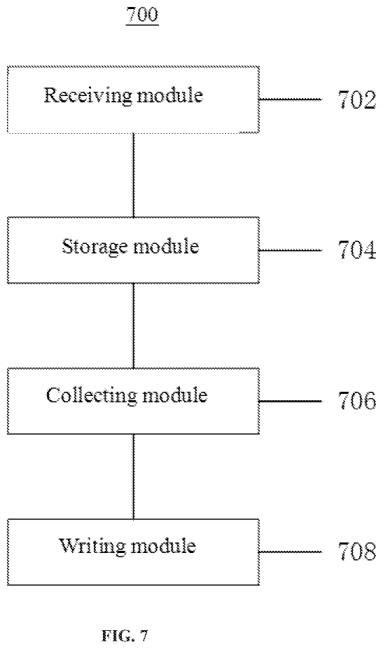

FIG. 7 is a schematic view of a fabric detecting and recording apparatus according to another embodiment of the present disclosure. The apparatus 700 may be implemented by using software, hardware or a combination of software and hardware. Since the embodiment of the apparatus 700 is basically similar to the embodiment of the method, the description is given briefly, and references may be made to the description of the method embodiment for related parts. Referring to FIG. 7, the apparatus 700 includes a receiving module 702 for receiving a detection data packet of a fabric to be detected, and a storage module 704 for storing the detection data packet in a memory pool. The detection data packet includes a fabric identification of the fabric to be detected and a detecting data corresponding to a current detection part of the fabric to be detected.

In one aspect, the apparatus 700 further includes a collecting module 706 for collecting the detection data packet in the memory pool that meets a preset rule when a preset condition is satisfied; and a writing module 708 for generating a block and writing the block into a blockchain according to the collected detection data packet.

The apparatus provided by the embodiment of the present disclosure is introduced from a view of functional modularity, and the device provided by the embodiment of the present disclosure is described hereafter from a view of hardware materialization.

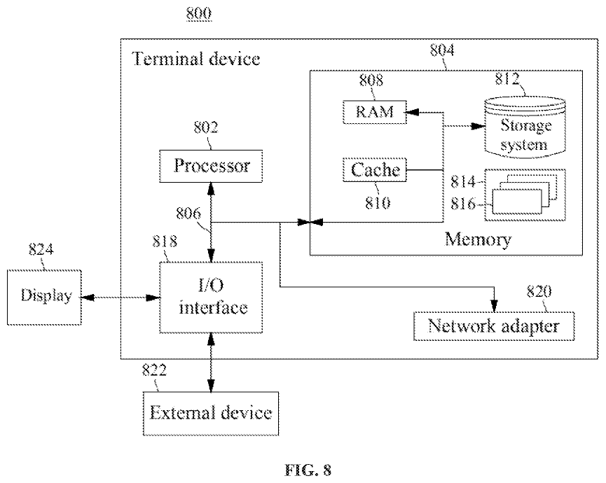

Please refer to FIG. 8, which is a schematic view of a terminal device according to the embodiment of the present disclosure. As shown in FIG. 8, in order to facilitate the description, only relevant parts of the embodiment of the present disclosure are shown, and specific technical details are not disclosed, please refer to the method embodiment of the present disclosure. The terminal device may include any terminal devices such as a tablet computer, a notebook computer, or a desktop computer, and the desktop computer is taken as an example hereafter.

As shown in FIG. 8, the terminal device 800 may include a processor 802 and a memory 804 having executable instructions stored therein. When the executable instructions are executed to cause the processor 802 to perform the method shown in FIG. 4.

As shown in FIG. 8, the terminal device 800 may further include a bus 806 for connecting different system components (including the processor 802 and the memory 804). The bus 806 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component interconnects (PCI) bus.

The terminal device 800 typically includes a variety of computer system readable media. Those computer readable media can be any available media that can be accessed by the terminal device 800 and includes both volatile and non-volatile media, removable and non-removable media.

The memory 804 may include computer system readable media in the form of volatile memory, such as random access memory (RAM) 808 and/or cache memory 810. The terminal device 800 may further include other removable/non-removable, volatile/nonvolatile computer system storage media. By way of example only, a storage system 812 may be used to read and write non-removable and non-volatile magnetic media (not shown in FIG.8 and typically called a “hard drive”). Although not shown in FIG. 8, a disk drive for reading from and writing to removable non-volatile disks (e.g., “floppy disks”) and an optical disk drive for reading from and writing to removable non-volatile optical disks (e.g., CD-ROM, DVD-ROM or other optical media) can be provided. In such instances, each drive can be connected to the bus 806 by one or more data media interfaces. The memory 804 may include at least one program product having a set (e.g., at least one) of program modules that are configured to carry out the functions in FIG. 4 according to the above-mentioned embodiment of the present disclosure.

Program/utility 814, having a set of (at least one) program module 816 may be stored in the memory 804 by way of example. Such program modules 816 include, but are not limited to, an operating system, one or more application programs, and program data, and each of these examples or some combination may include an implementation of a networking environment. In generally, the program module 816 performs the functions and/or methods in FIG. 4 according to the above-mentioned embodiment of the present disclosure as described herein.

The terminal device 800 may further communicate with one or more external devices 822 (e.g., a keyboard, a pointing device, a display 824, etc.); one or more devices that enable a user to interact with the terminal device 800; and/or any devices (e.g., network card, modem, etc.) that enable the terminal device 800 to communicate with one or more other computing devices. Such communication can occur via I/O interfaces 818. Besides, the terminal device 800 can also communicate with one or more networks (e.g., a local area network (LAN), a general wide area network (WAN), and/or a public network such as the Internet) via a network adapter 820. As depicted, the network adapter 820 communicates with the other components of the terminal device 800 via the bus 806. It should be understood that although not shown, other hardware and/or software components could be used in conjunction with the terminal device 800. Examples include but not limit to: microcode, device drivers, redundant processing units, external disk drive arrays, RAID systems, tape drives, and data archival storage systems, etc.

The processor 802 runs a program stored in the memory 804 to perform various functional application and data processing, for example, to realize the fabric detecting and recording method shown in the above-mentioned embodiments.

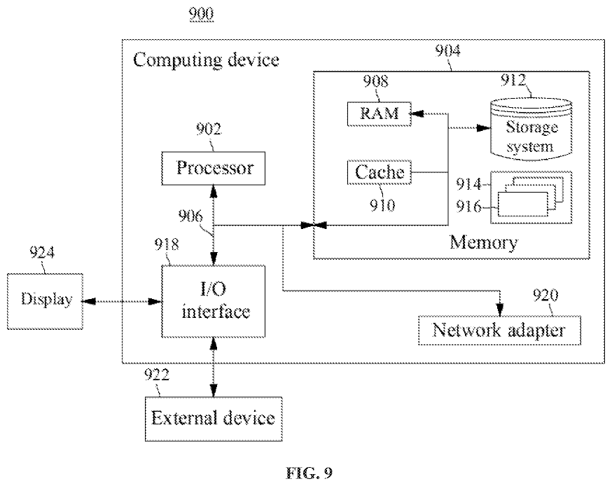

The embodiment of the present disclosure further provides a computing device. Please refer to FIG. 9, which is a schematic view of a computing device according to an embodiment of the present disclosure. As shown in FIG. 9, in order to facilitate the description, only relevant parts the embodiment of the present disclosure are shown, and specific technical details are not disclosed, please refer to the method embodiment of the present disclosure. The terminal device may include any terminal device such as a tablet computer, a notebook computer, or a desktop computer, and the desktop computer is taken as a terminal device hereafter.

As shown FIG. 9, the terminal device 900 may include a processor 902 and a memory 904 having executable instructions stored therein. When the executable instructions are executed to cause the processor 902 to perform the method shown in FIG. 5.

As shown in FIG. 9, the terminal device 900 may further include a bus 906 for connecting different system components (including the processor 902 and the memory 904). The bus 906 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component interconnects (PCI) bus.

The terminal device 900 typically includes a variety of computer system readable media. Those computer readable media can be any available media that can be accessed by the terminal device 900 and includes both volatile and non-volatile media, removable and non-removable media.

The memory 904 may include computer system readable media in the form of volatile memory, such as random access memory (RAM) 908 and/or cache memory 910. The terminal device 900 may further include other removable/non-removable, volatile/nonvolatile computer system storage media. By way of example only, a storage system 912 may be used to read and write non-removable and non-volatile magnetic media (not shown in FIG. 8 and typically called a “hard drive”). Although not shown in FIG. 9, a disk drive for reading from and writing to removable non-volatile disks (e.g., “floppy disks”) and an optical disk drive for reading from and writing to removable non-volatile optical disks (e.g., CD-ROM, DVD-ROM or other optical media) can be provided. In such instances, each drive can be connected to the bus 906 by one or more data media interfaces. The memory 904 may include at least one program product having a set (e.g., at least one) of program modules that are configured to carry out the functions in FIG. 5 according to the above-mentioned embodiment of the present disclosure.

Program/utility 914, having a set of (at least one) program module 916 may be stored in the memory 904 by way of example. Such program modules 916 include, but are not limited to, an operating system, one or more application programs, and program data, and each of these examples or some combination may include an implementation of a networking environment. In generally, the program module 816 performs the functions and/or methods in FIG. 5 according to the above-mentioned embodiment of the present disclosure as described herein.

The terminal device 900 may further communicate with one or more external devices 922 (e.g., a keyboard, a pointing device, a display 924, etc.); one or more devices that enable a user to interact with the terminal device 900; and/or any devices (e.g., network card, modem, etc.) that enable the terminal device 900 to communicate with one or more other computing devices. Such communication can occur via I/O interfaces 918. Besides, the terminal device 900 can also communicate with one or more networks (e.g., a local area network LAN), a general wide area network (WAN), and/or a public network such as the Internet) via a network adapter 920. As depicted, the network adapter 920 communicates with the other components of the terminal device 900 via the bus 906. It should be understood that although not shown, other hardware and/or software components could be used in conjunction with the terminal device 900. Examples include but not limit to: microcode, device drivers, redundant processing units, external disk drive arrays, RAID systems, tape drives, and data archival storage systems, etc.

The processor 902 runs a program stored in the memory 904 to perform various functional applications and data processing, for example, to realize the fabric detecting and recording method shown in the above-mentioned embodiments.

The embodiment of the present disclosure further provides a computer storage medium for storing program codes, wherein the program codes are used to perform any one of the fabric detecting and recording method described in the above-mentioned various embodiments.

The computer storage medium of this embodiment may include a RAM 808, and/or a cache memory 810, and/or a storage system 812 stored in the memory 804 according to the embodiment shown in FIG. 8; or a RAM 908 904, and/or a cache memory 910, and/or a storage system 912 stored in the memory 904 according to the embodiment shown FIG. 9. The computer storage medium in this embodiment may include not only tangible media, but also intangible media.

The embodiment of the present disclosure further provides a computer program product. When an instruction stored in the computer program product is executed by the processor, any one of the implementations of the fabric detecting and recording method described in the above-mentioned embodiments is performed.

Those skilled in the art shall understand that the embodiments of the present disclosure may be provided as a method, a device or a computer program product. Accordingly, the present disclosure can be implemented in the form of complete hardware embodiment, complete software embodiment or hardware and software combined embodiment. In addition, the present disclosure can be in a form of one or more computer programs containing computer-executable codes which can be implemented in the computer-executable storage medium (including but not limited to disks, CD-ROM, optical disks, etc.).

The present disclosure is described by referring to the flow charts and/or block views of the method, device and computer program of the embodiments of the present disclosure. It should be understood that each flow and/or block and the combination of the flow and/or block of the flowchart and/or block view can be implemented by computer program instructions. These computer program instructions can be provided to general computers, specific computers, embedded processor or other programmable data processors to generate a machine, so that a device of realizing one or more flows of the flow chart and/or one or more blocks of the block view can be generated through the instructions operated by a computer or other programmable data processors.

What is claimed is:

1. A fabric detecting and recording method comprising:
acquiring a fabric identification of a fabric to be detected;
acquiring an image data of a current detecting part of the fabric to be detected;
detecting the image data to generate a detection data corresponding to the detecting part;
packaging the fabric identification and the detecting data into a detection data packet, and sending the packet to a blockchain network for broadcasting.

2. The fabric detecting and recording method according to claim 1, wherein, when detection of all detecting parts of the fabric to be detected has been completed, the method further comprises:
sending a preset instruction to the blockchain network so that nodes in the blockchain network collect the detection data packet that meets a preset rule, and generate a block for writing into the blockchain according to the collected detection data packet.

3. A fabric detecting and recording method comprising:
receiving a detection data packet of a fabric to be detected, wherein the detection data packet includes a fabric identification of the fabric to be detected and a detecting data corresponding to a current detecting part of the fabric to be detected;
storing the detection data packet in a memory pool;
when satisfying a preset condition, collecting the detection data packet that meets a preset rule in the memory pool;
generating a block according to the collected detection data packet and writing the block into a blockchain.

4. The fabric detecting and recording method according to claim 3, wherein
said satisfying a preset condition includes having received a preset instruction, reaching a preset time, or the number of detection data packets stored in the memory pool reaching a preset threshold.

5. The fabric detecting and recording method according to claim 3, wherein
said meeting a preset rule includes having the same fabric identification or storing in the memory pool at the same time period.

6. The fabric detecting and recording method according to claim 3, wherein said generating a block according to the collected detection data packet and writing the block into a blockchain specifically comprises: calculating a root hash value of the Merkel tree according to hash values of the fabric identification and the detection data of the collected detection data packet;
acquiring a timestamp of a current block;
acquiring a hash value corresponding to a previous block;
setting the hash value corresponding to the previous block, the root hash value of the Merkel tree and the timestamp into a block header of the current block, and setting the fabric identification and detection data to into a main body of the current block, thus to generate a current block;
adding the current block to an end of the blockchain; and
broadcasting the blockchain.

7. A fabric detecting and recording apparatus comprising:
a first acquiring module for acquiring a fabric identification of a fabric to be detected;
a second acquiring module for acquiring an image data of a current detection part of the fabric to be detected;
a detection generating module for detecting the image data to generate a detection data corresponding to the detecting part; and
a package sending module for packaging the fabric identification and the detection data into a detection data packet and sending the packet to a blockchain network for broadcasting.
